(19) United States
(12) Patent Application Publication
(10) Pub. No.: US 2008/0303827 A1
(43) Pub. Date: Dec. 11, 2008

(54) Methods and Systems for Animating Displayed Representations of Data Items

(75) Inventor: Michael Schiff, San Francisco, CA (US)

Correspondence Address: Kilpatrick Stockton LLP- Adobe Systems, Inc. 58083, Kilpatrick Stockton LLP, 1100 Peachtree Street, Atlanta, GA, 30309-4530, US

(73) Assignee: Adobe Systems Incorporated, San Jose, CA (US)

(21) Appl. No.: 11/761,197

(22) Filed: Jun. 11, 2007

(51) Int. Cl. G06T 13/00

(52) U.S. Cl. 345/473

(57) ABSTRACT

Methods and systems for animating visual components representing data items. One embodiment comprises a method for producing an application using declarative language code to specify animation behavior for data item representations. A programming application may be used to create the declarative language code using a display design area for placing and adjusting objects such as data item containers and/or an editor for entering and editing code. One embodiment comprises a method that allows an application, such as a rich Internet application, to create representations of displayed objects and virtually displayed objects to facilitate animation. One embodiment involves facilitating animation using initial and changed layouts, such layouts including representing of a limited number of data items both inside and outside the content display area. In certain embodiments, a computer-readable medium (such as, for example random access memory or a computer disk) comprises code for carrying out these and other methods.

### FIELD OF THE INVENTION

The present invention relates generally to methods and systems for animating displayed representations of data items, including methods and systems for providing a declarative language for specifying animation and for using virtualization.

### BACKGROUND

As the name implies, rich Internet applications are richer in features than basic web applications, such as HTML applications. Among other things, rich applications typically offer interactive user-interface and animation behaviors not available in most basic web applications. Other examples of enhanced behavior include drag and drop tools, drop down menus, sliders for changing data, and the ability to perform calculations by the client (e.g., without using a remote server). Such applications come in a variety of forms and are designed for execution in different contexts. The Adobe® Flash® Player is an example of a client application often available in web browsers that executes many types of rich Internet applications.

Various tools exist for developing rich Internet applications, including the Adobe® Flex® application development solution, which provides a framework for building applications that run within the Adobe® Flash® Player runtime. Programming on the Adobe® Flex® product primarily involves using a mix of a standards-based, object-oriented programming language called ActionScript and a declarative, XML-based language called MXML. The developer writes ActionScript and MXML source code using the Flex Builder integrated development environment (“IDE”) or a standard text editor and then compiles the code into bytecode. Flex® includes a class library that provides a collection of classes used to provide an application programming interface (“API”) comprising various containers (Application, VBox, etc.), controls (Button, TextInput, etc.), and other data, manager, and utility classes. Flex® Data Services provide components for allowing access to various data sources. Without necessarily understanding specifics of user interface controls and containers, a programmer can define a rich and powerful application or interface. Once the Action Script and MXML is complete, a rich Internet application is created by compiling the MXML and any associated ActionScript into bytecode, resulting in a binary file (e.g., a .swf file), that can execute in the Adobe® Flash® Player runtime environment.

One advantage of using of a declarative language like MXML to program rich Internet applications is that a programmer can declaratively (and with relative ease) lay-out the display or user interface of the application and implement complex logic and other behaviors. For example, the visual components defined in a MXML application each have an identifier that is a way of referencing it in the MXML, e.g. “Button0” could be the identifier for a button that is displayed. A programmer can specify a general, visual, or animating effect in the MXML, for example, with a simple declarative command such as <Fade target=”Button0” from “0.0” duration “250”>. However, development of rich Internet applications, using MXML and other such languages, is limited with respect to animating representations of data items, i.e., animating the objects within data-driven components.

### SUMMARY

Embodiments of the present invention provide methods and systems for animating displayed representations of data items. One embodiment is a method of animation comprising receiving a code in a declarative language format and using the declarative language code and a library to generate an application displaying the container and animating a data item representation within the display of the container. The code may comprise a (a) first syntax identifying a container for displaying representations of data items and (b) a second syntax specifying a data item animation effect for the data item representations. The library may comprise procedures or instructions callable by code in the declarative programming language format for displaying containers and for displaying one or more animation effects for the representations of data items.

One embodiment is a method of animation comprising providing a library, providing a coding application for creating and editing declarative programming language code, receiving a file containing declarative language code from the coding application, and generating a computer application using the library and the file of declarative language code. The library may comprise instructions for displaying a container and for displaying an animation effect for representations of data items within a displayed container. The programming application may comprise a text editor and a display design interface for creating and editing the declarative programming language code.

One embodiment is a method of animation comprising specifying a source of a collection of data items for display in a content display area, determining and recording an initial layout, determining and recording a changed layout based on a change, and animating a displayed representation of one or more of the data items using the initial layout and the changed layout. Such layouts may comprise locations for representations of a limited number of the data items, with some of the locations within a content display area and some of the locations outside of the content display area.

In other embodiments, a computer-readable medium (such as, for example random access memory or a computer disk) comprises code for carrying out these methods.

These embodiments are mentioned not to limit or define the invention, but to provide examples of embodiments of the invention to aid understanding thereof. Embodiments are discussed in the Detailed Description, and further description of the invention is provided there. Advantages offered by the various embodiments of the present invention may be further understood by examining this specification.

### BRIEF DESCRIPTION OF THE FIGURES

These and other features, aspects, and advantages of the present invention are better understood when the following Detailed Description is read with reference to the accompanying drawings, wherein:

FIG. 1 is a system diagram illustrating an illustrative network environment according to one embodiment of the present invention;

FIG. 2 is an exemplary integrated development environment according to one embodiment of the present invention;

FIG. 3 is an exemplary integrated development environment according to one embodiment of the present invention;

FIGS. 4a-e illustrate an application showing animation of representations of data objects according to one embodiment of the present invention;

FIG. 5 is a flow chart illustrating one method of using declarative code to generate an application that displays animation according to one embodiment of the present invention;

FIG. 6 is a flow chart illustrating one method of using declarative code to generate an application that displays animation according to one embodiment of the present invention;

FIG. 7 is a flow chart illustrating one method for animating representations of data items according to one embodiment of the present invention;

FIG. 8 is a flow chart illustrating one method of using declarative code to generate an application that displays animation according to one embodiment of the present invention;

FIGS. 9a-d illustrate representations of data items according to one embodiment of the present invention; and

FIGS. 10a-d illustrate representations of data items according to one embodiment of the present invention.

### DETAILED DESCRIPTION

Embodiments of the present invention provide methods and systems for animating displayed representations of data items, such as animations within a rich Internet application.

### Illustrative Application Including Animated Data-Driven Display

In one illustrative embodiment, a user accesses a web site to obtain content related to a topic of interest. The user is presented a display, executing in the Flash runtime environment, containing a listbox with list entries representing blog entries relating to the topic of interest. Each entry displayed in the listbox is a representation of some or all of the data associated with each blog entry. The entries displayed in the list box may be icons, text, images, links, or any other suitable representations of the blog content.

Certain animation behavior may be applied to the representations of the blog entries shown in the list. For example, in one embodiment, when the representations are loaded or brought into view, they may fade into view, slide into view from one side of the list box, or appear in a timed-delayed sequence one after another. Further animation may be triggered by user action. For example, if a user deletes a blog entry, the representation of a deleted blog entry may fade out and the remaining blog entries may appear to move together to fill the empty space.

Such a display of a listbox with representations of blog entries may have been specified or designed by a developer using tools, techniques, and principles of embodiments of the present invention. For example, a developer may have specified the displayed listbox and the animation behaviors to be applied to representations of data items within the listbox in a declarative programming language and generated bytecode that implements the display and animation behaviors. Some animation behaviors may have been specified to apply consistently to all of the represented blog entries in the list without the designer having to write code or otherwise specifically account for the special cases of the first, middle, last, or any other displayed representation of a blog entry.

The area or portion of the data container (e.g., the listbox) or user interface on which representations of data items are displayed is referred to as the content display area. Embodiments of the present invention may allow an application to animate representations moving to and from a content display area by virtualizing the starting and/or ending positions of the representations when such positions are outside of the content display area. For example, in one embodiment, the application generates representations for blog entries that are visible in the listbox control and for blog entries that are not visible. For instance, if twenty entries are shown, the application generates representations for those twenty entries and also generates representations for the five entries immediately preceding and following those twenty entries. And while only twenty blog entries are visible to the user, all thirty blog entries are available to the application for accomplishing an animation behavior specified by the application developer.

This illustrative example is given to introduce the reader to the general subject matter discussed herein. The invention is not limited to this example. The following sections describe various additional embodiments and examples of methods and systems for animating displayed representations of data items.

### Illustrative Network Configuration for Providing a Rich Internet Application

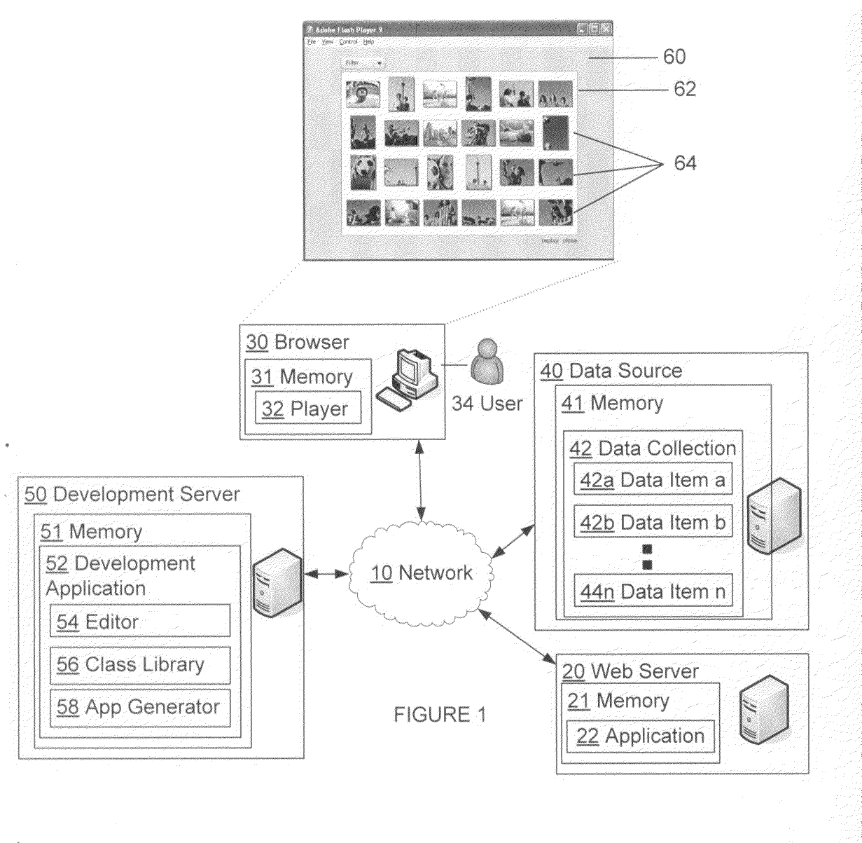

Referring now to the drawings in which like numerals indicate like elements throughout the several figures, FIG. 1 is a system diagram illustrating an illustrative network environment according to one embodiment of the present invention Other embodiments may be utilized. FIG. 1 illustrates an exemplary network environment for developing and providing an application, such as a rich Internet application, capable of animating data-driven objects. Generally a “data-driven” or data “container” component is a software component that applies an algorithm to some data to produce a visual presentation of the data (i.e., the positions, sizes, and other properties of a set of items that are rendered graphically). In such a component, changing the underlying data may result in a change to the visual display and/or a change in the visual display may result in a change to the underlying data. Other sources of change are described herein and known to those in the art.

The system 100 shown in FIG. 1 comprises a wired or wireless network 10 connecting multiple server devices 20, 40, 50 and a client computer executing an Internet browser application 30. Applications that execute on each of the devices 20, 30, 40, and 50 are shown as functional components residing in memory 21, 31, 41, and 51 on the respective devices As is known to one of skill in the art, such applications may be resident in any suitable computer-readable medium and execute on a any suitable processor. For example, the network devices 20, 30, 40, 50 shown each may comprise a computer-readable medium such as a random access memory (RAM) 21, 31, 41, 51, coupled to a processor that executes computer-executable program instructions stored in memory. Such processors may comprise a microprocessor, an ASIC, a state machine, or other processor, and can be any of a number of computer processors, such as processors from Intel Corporation of Santa Clara, Calif. and Motorola Corporation of Schaumburg, Ill. Such processors comprise, or may be in communication with, media, for example computer-readable media, which stores instructions that, when executed by the processor, cause the processor to perform the steps described herein.

Embodiments of computer-readable media comprise, but are not limited to, an electronic, optical, magnetic, or other storage or transmission device capable of providing a processor with computer-readable instructions. Other examples of suitable media comprise, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

The network 10 shown comprises the Internet. In other embodiments, other networks, such as an intranet, or no network may be used. Moreover, methods according to the present invention may operate within a single device. The devices 20, 30, 40, 50 can be connected to a network 10 as shown. Alternative configurations are of course possible. For example, a development environment, such as development server 50, need not be connected to a network. As another example, a data source 40, web server 20, and/or browser 30 could all be on a single machine, for example, for generating test code. The devices 20, 30, 40, 50 may also comprise a number of external or internal devices such as a mouse, a CD-ROM, DVD, a keyboard, a display, or other input or output devices. Examples of devices that could execute a browser 30 are personal computers, digital assistants, personal digital assistants, cellular phones, mobile phones, smart phones, pagers, digital tablets, laptop computers, Internet appliances, and other processor-based devices. In general, a computer device executing the Internet browser 30 may be any type of processor-based platform that operates on any operating system, such as Microsoft® Windows® or Linux, capable of supporting one or more client application programs. For example, the browser device 30 shown comprises a personal computer executing client application programs including a web browser application. Other client applications can be contained in memory and can comprise, for example, a word processing application, a spreadsheet application, an e-mail application, a media player application, an instant messenger application, a presentation application, an Internet browser application, a rich Internet application player 32, a calendar/organizer application, and any other application or computer program capable of being executed by a client device. The server devices 20, 40, 50 depicted as single computer systems, may be implemented as a network of computer processors. Examples of a server device are servers, mainframe computers, networked computers, a processor-based device, and similar types of systems and devices.

An illustrative development machine 50 is a developer's client machine. As an example, a developer might develop the application on development machine 50 and then move it to the web server 20 so that a user can access it. The developer could use a development application 52 comprising an editor 54, a library 56, and an application generator 58. The development application 52 allows a user to create a declarative code and use the application generator 58 to compile the declarative code with procedures from the library to generate an application. The developer may also use the development application 52 and/or other applications such as a web browser (not shown) to run, test, or for other purposes. The compiling may involve first converting the declarative code into procedural script and compiling the procedural script, possibly with additional procedural script, into an executable application, such as a rich Internet application.

A rich Internet application generated using the development application 52 may be stored as an Internet accessible application 22 on web server 20. The application 22 may be made available on the Internet, for example, to Internet browser applications such as browser 30 and its rich Internet application player 32. The application may contain references or other calls to data items, either with the application itself, on the local web server 20, or on some other Internet accessible location such as on data source 40. As an illustrative example, data source server 40 comprises a data collection 42 that is referenced by the application 40. During execution of the rich Internet application 22 on player 32, the application causes one or more data items 42a-n of the data collection 42 to be retrieved from the data source server 40.

As an illustrative example, an executing, rich Internet application 22 on a player 32 could provide a display 60 on a user computing device. The display 60 comprises a displayed container 62 that in this case is specified by the application 62 and representations of data items 64, the location of these data items also specified by the application. In this example, representations 64 correspond to the individual data elements 42a-n provided by data source server 40.

Certain embodiments of the present invention relate to methods of animating representations in data-driven containers, for example animating the representations 64 of data elements 42a-n displayed in container 62. It will be recognized that this is merely one context for the methods of animation and other features of the invention described herein. For example, certain embodiments will not involve a network, certain embodiments will not involve the use of declarative code, and certain embodiments will not involve a rich Internet application. In short, the techniques for animation and the other features described herein have uses in a variety of contexts, not to be limited by the specific illustrations provided herein. It should also be noted that embodiments of the present invention may comprise systems having different architecture than that which is shown in FIG. 1. For example, in some systems according to the present invention, a server device may comprise a single physical or logical server. The system shown in FIG. 1 is merely illustrative and is not intended to recite any system component or feature as essential or necessary to any embodiment of the invention.

### Illustrative Embodiment of a Development Application Interface

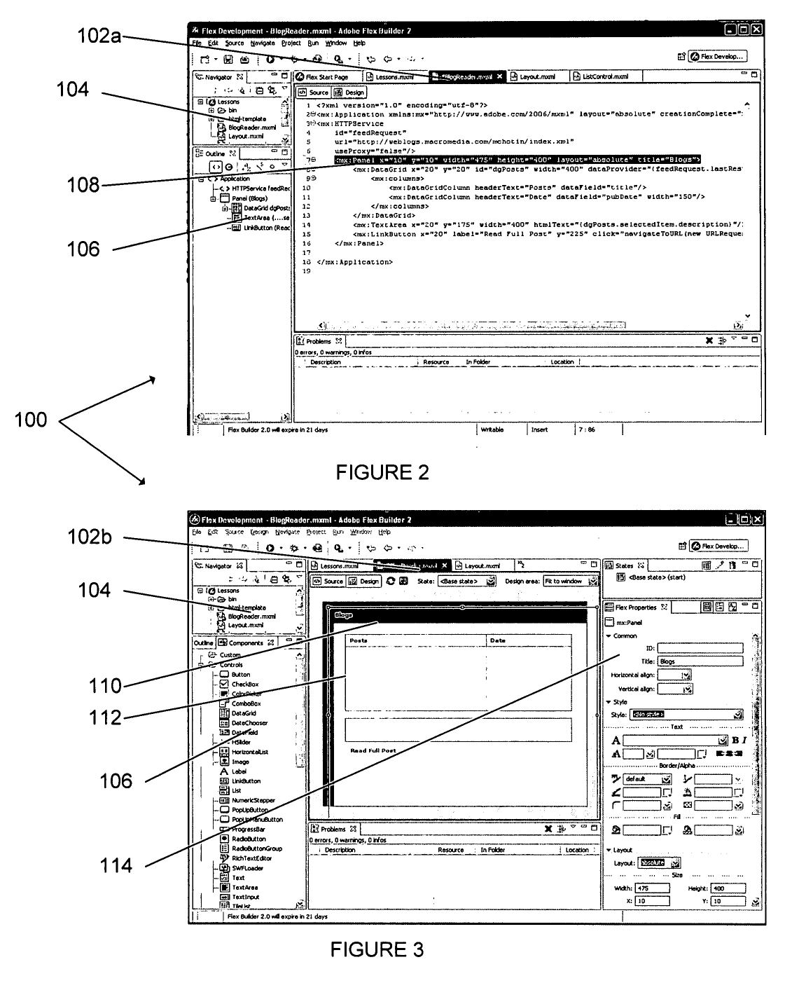

FIGS. 2 and 3 illustrate an illustrative integrated development environment (“IDE”) 100 according to one embodiment of the present invention. Such an IDE may be used in developing an application containing animated data-driven objects according to embodiments of the present invention. The IDE 100 offers two primary development options illustrated respectively in FIGS. 2 and 3. Navigation between the various tools available within the IDE is controlled by selection of an appropriate tab 102a, 102b. FIGS. 2 and 3 illustrate a file management window 104 for managing declarative code files created or imported into to the IDE 100, a reference window 106 for selecting and working with various containers, controls, and other components (Application, VBox, Button, TextInput, etc.). FIG. 2 illustrates a text editor window 108 for manually entering and editing code in a declarative language. In one mode of operation, the reference window 106 displays an outline of the declarative language code in the editor.

FIG. 3 illustrates a graphic design window 110 in which a user can place containers, controls, and other components. For example, graphic design window 110 includes a container object 112 labeled “Posts.” The graphic depiction of the container 112 in design window 110 graphically resembles, with respect to shape and position within the display area, the container object that will be displayed when the application being developed is executed. The IDE 100 correlates what is shown on the graphic design window 110 of FIG. 3 with the declarative code shown in the editor window 108 of FIG. 2. In other words, changes to the code in the editor window 108 are reflected in what is displayed in the graphic design window 110 of FIG. 3, and vice versa. The ability to navigate between text and graphic design interfaces provides flexibility in the creation of declarative code for animating visual representations of data. The properties window 114 shown in FIG. 3 offers additional flexibility for inputting parameters and other properties that are reflected in the display window of FIG. 3 and in the editor window 108 of FIG. 2.

Certain embodiments of the present invention provide a library or libraries, e.g., of instructions or procedures, that is used in compiling declarative code into bytecode, which may be executed in a runtime environment. The IDE 100 illustrated in FIGS. 2 and 3 may provide constraints or other features that facilitate the creation of declarative code that utilizes the library. For example, properties of the declarative language objects displayed in the graphic design window of IDE 100 may relate to animation effects of the objects themselves or of representations of data items displayed within container objects. Thus embodiments of the present invention can extend a declarative language design interface, such as the one depicted in FIGS. 2 and 3, to allow for declarative code that controls or otherwise specifies animation of data-driven components.

### Illustrative Embodiment of Declarative Language Embodiments

One embodiment of the present invention provides a way to use a flexible, declarative markup language to describe animated transitions corresponding to data changes. Such an embodiment provides the advantage of allowing designers to specify animation using high level declarative code that is simpler to write, understand, and maintain than more complex or lower level procedural code. It provides a means of specifying animations via declarative markup language for an implicitly specified set of visual components corresponding to data items being represented visually. It also provides a means of declaratively specifying restrictions on animations based on how data being presented visually has changed.

One example of an application displaying representations of data items and that can be specified using high level declarative code is the web log example described above. Other examples of such applications include a list of MP3's displayed as a vertical list of song titles and album cover images, or a set of photos presented using a grid of thumbnail images with a text label beneath each image. Such applications are sometimes referred to as “data-driven” because the visual presentation is defined in a general manner that can be used with arbitrary data. Control of the creation, deletion, and modification of individual visual components and of the underlying data may be controlled by functions callable by declarative language code. Thus, the declarative language calls are an alternative to a more conventional procedural programming language that is harder to write, edit, and debug.

For example, in one embodiment of the present invention for displaying photos, if a user deletes a photo, the application developer might want the associated thumbnail to fade out and the other thumbnails to slide to their new positions in the grid. In conventional development environments, the developer would have to overcome various hurdles to achieve such an animation behavior. For, example, a rich Internet application developed to display a listbox with icons representing blogs retrieved from a remotely-located and non-static blog hosting web site would require detailed procedural programming to describe animation behavior that might account for potentially unknown data characteristics. Embodiments of the present invention allow the developer to specify such behaviors declaratively without necessarily having to write procedural code to animate the components. Such an embodiment provides a convenient declarative way to animate visual representations of data items, without the need to explicitly refer to each visual representation. This can be accomplished even though the specific starting and ending properties of each visual representation can vary greatly depending on the data being presented.

A rich Internet application development framework may be used for specifying animation of data item representations, and may include tools (e.g., functions or procedures callable or otherwise specifiable from declarative language code) that may apply universally to representations of data items in a container. Such functions may apply to the representations of the first, middle, and last data items displayed without requiring an application designer to distinguish or specifically account for specific cases.

Applications according to embodiments of the present invention may specify a variety of animation behaviors. For example, data representations may fade into view, slide into view from one side of a list box, or appear in a timed-delayed sequence one after another. An application may also specify animation triggered by user action. For example, if a user deletes a representation of a data item in a list box, the deleted item may fade out and the remaining items may appear to move so that a remaining item fills the voided area. Generally, many, if not all, types of animation involving change of the representations of one or more individual data items that occurs over time may be specified by the application designer, including deletion, insertion, replacement, movement, zooming, and magnifying.

One illustrative embodiment provides an extension to a library of callable procedures available in the Adobe® Flex® framework. Such procedures may correspond to the declarative language already used by Flex® to describe visual effects for objects not associated with data items. The extensions to the library allow restricting which visual components are animated based on how the data is changing and based on the overall visual presentation before and after the data has changed. In addition, the language may be extended to provide for the addition of new visual components or the removal of existing visual components resulting from changes in the data. For example, in one embodiment, the language extensions make it possible to specify that when two photos are deleted from a collection, the thumbnail images and text labels representing those particular photos on screen should fade out over 200 ms, and then the images and text representing the other photos should smoothly animate to their new positions in a grid.

The following is an example declarative syntax:

```
<sequence>
    <fade filter=“removed” alphaTo=“0.0” duration=“200”/>
    <removeItem filter=“removed” />
    <move filter=“remaining” duration=“200”/>
</sequence>
```

In one embodiment, the animation functionality for representations of data items within a container involves an extension of existing filters associated with the container object. Rather than examining the object itself, the filters may be extended to communicate to the list component in which the data item is displayed to obtain information about a particular data item, e.g., one that was identified by a user action during execution of the application. Existing functions that monitor for data changes may be extended to communicate specific data item changes for use in functions that provide animation for representations of data items. For instance, in one such embodiment, upon some triggering event, all represented items are identified as potential items for some effect. Once the representations have been identified, items that require changes or are otherwise impacted can be animated to implement the animation effect. Alternatively, upon some triggering event, items that are to be impacted can be determined.

### Illustrative Embodiment of Animation

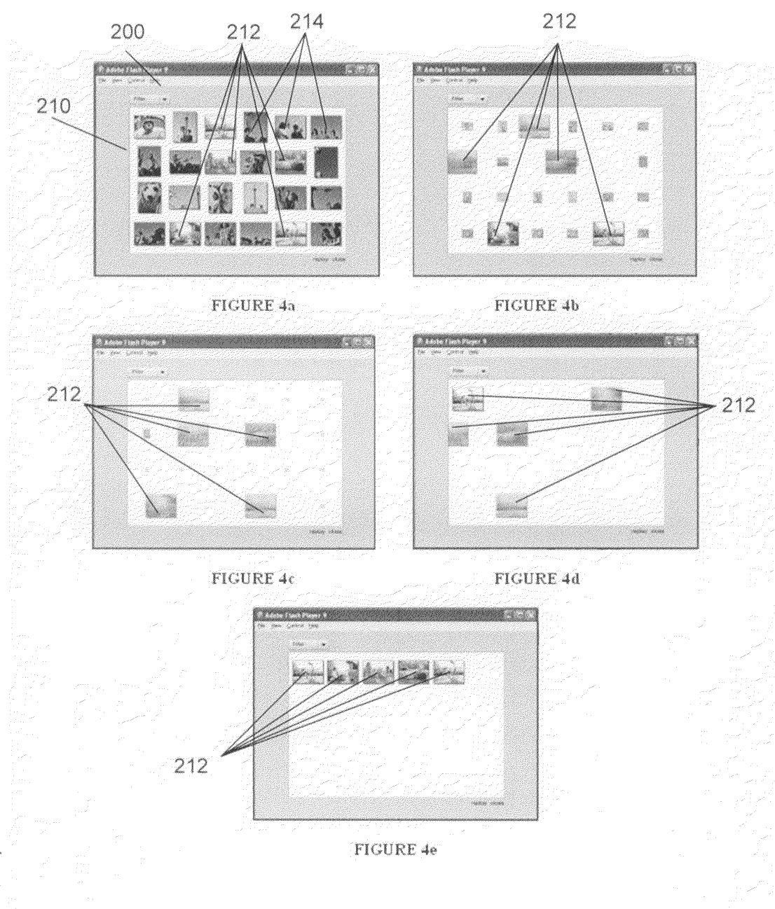

FIG. 4a-e illustrate an application showing animation of representations of data objects according to one embodiment of the present invention. In FIG. 4a, an application display 200 comprises a data item container 210 containing various representations of data items 212, 214. For purposes of illustration, some of the representations are for data items associated with summer, summer representations 212, and some of the representations are for data items not associated with summer, non-summer representations 214. FIG. 4a displays both summer representations 212 and non-summer representations 214.

In the example shown in FIGS. 4a-4e, an event occurs that specifies a change to the displayed representations. Specifically, an event occurs specifying that only representations of summer events are to be displayed, which ultimately results in a display such as the display shown in FIG. 4e displaying only the summer representations 212. The event may be triggered by a user action (e.g., selecting a user interface button on display 200) but need not be triggered by a user action. The event could be triggered by a change to the underlying data (for example, if all non-summer data items were removed from the underlying data collection). The event could instead be triggered by an application executing or otherwise displaying or modifying the display 200.

FIGS. 4b, 4c, and 4d illustrate intermediate displays between the initial layout displayed in FIG. 4a and the changed layout displayed in FIG. 4e. To provide animation, the display could display these and other intermediate displays over a generally short period of time to give the appearance of movement or other animation to one or more of the representations of data items. This example is merely illustrative of a few intermediate displays. One of ordinary skill would understand that the animation described may require one or more additional intermediate displays; however, these additional displays are omitted from FIGS. 4b-4d for the sake of brevity. Note that, in this example, after the non-summer representations 214 are removed from the display (here they have faded out completely) as shown in FIG. 4d, the remaining summer representations 212 will move (or appear to move) generally leftward until they have moved off the screen completely, to reappear on far right side of the row above, where they again move generally leftward. This movement continues until the representations 212 come to their changed positions as illustrated in FIG. 4e.

### Illustrative Embodiments of Methods of Animation

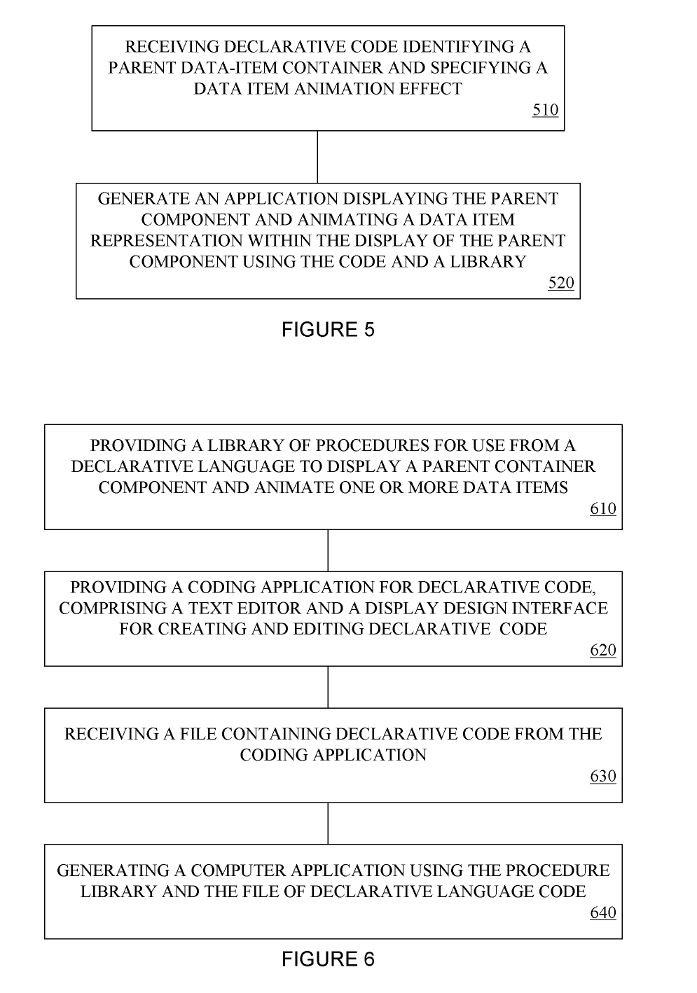

FIG. 5 is a flow chart illustrating one method of using declarative code to generate an application that displays animation according to one embodiment of the present invention. For purposes of illustration only, the elements of this method are described with reference to the system depicted in FIG. 1. A variety of other implementations are also possible.

In the method shown in FIG. 5, a development application 50 receives declarative code identifying a parent data-item container (e.g., a list box) and specifying a data item animation effect as shown in block 510. The declarative code may have been developed using an editor portion 54 of the development application. The declarative code can be any code in declarative language format and will generally comprise a first syntax identifying a container for displaying representations of data items. For example, the syntax may identify a listbox to be displayed on a certain portion of a display with a certain portion of the listbox used to display representations of data items found at some specified source location such as a website of blogs. An example of syntax specifying a container is shown below:

```
<mx:DataGrid x=“20” y=“20” id=“dgPosts” width=“400”
      dataProvider= “{feedRequest.lastResult.rss.channel.item}”>
  <mx:columns>
    <mx:DataGridColumn headerText=“Posts” dataField=“title”/>
    <mx:DataGridColumn headerText=“Date” dataField=“pubDate”
    width=“150”/>
  </mx:columns>
</mx:DataGrid>
```

The declarative code will generally also comprise a second syntax specifying a data item animation effect for the data item representations. The following are examples of this type of syntax:

<fade filter=“removed” alphaTo=“0.0” duration=“200”/>
<removeItem filter=“removed” />
<move filter=“remaining” duration=“200”/>

In the method shown in FIG. 5, an application generator 58 portion of the development application 52 then generates an application displaying the container and animating a data item representation within the display of the container using the code and a library as shown in block 520. The library may contain procedure code used by the declarative programming language code. The procedures in this example comprise instructions for displaying containers and for displaying one or more animation effects for representations of data items. For example, the instructions may cause the display of an animation effect in response to a user action (e.g., deletion of a representation of a data item from a list box) on a computer executing the application. The instructions may provide for maintaining a data structure for tracking changes made to the one or more data items.

In one embodiment, using the declarative language code and a library to generate the application may further comprise generating procedural script from the declarative language and using the procedural script to compile the application. Examples of such procedural script include the Adobe® ActionScript® and JavaScript. The application may be a rich Internet application executable on the Adobe® Flash® runtime environment.

Generally, the declarative code is turned into very simple procedural code that initializes some data structures. The procedural library code operates on these data structures at initialization or else retains them for later. The following example illustrates declarative code that specifies some components, declarative code that specifies an effect, and exemplary generated procedure code for such components.

Some components may be specified by the followed exemplary declarative code:

```
<mx:TileList id=“tlist0” x=“10” y=“10” height=“400” width=“400”
    columnCount=“4” rowCount=“4” direction=“horizontal”
    dataProvider=“{collection0}” allowMultipleSelection=“true”
    offscreenExtraRows=“4” dataChangeEffect=“{dataChangeEffect1}”
    />
<mx:Button x=“495” y=“60” label=“Add item” click=“add1( )”/>
```

An effect may be specified by the following exemplary declarative code:

```
<mx:Parallel id=“dataChangeEffect1”>
  <mx:Sequence>
    <mx:Parallel filter=“removeItem”>
      <mx:Blur blurYTo=“12” blurXTo=“12” duration=“300”
        perElementOffset=“150” />
      <mx:Fade duration=“200” startDelay=“150”
      perElementOffset=“150”/>
    </mx:Parallel>
    <mx:Parallel>
      <mx:Move duration=“750” easingFunction=“{Elastic.easeOut}”
        perElementOffset=“20” />
      <mx:RemoveItemAction startDelay=“400” filter=“removeItem” />
      <mx:AddItemAction startDelay=“400” filter=“addItem” />
      <mx:Fade startDelay=“410” alphaFrom=“0.0” alphaTo=“1.0”
        duration=“100” filter=“addItem”/>
      <mx:Blur startDelay=“410” blurXFrom=“18” blurYFrom=“18”
        blurXTo=“0” blurYTo=“0” duration=“300”
        filter=“addItem”/>
    </mx:Parallel>
  </mx:Sequence>
</mx:Parallel>
```

The following illustrates generated procedural code for the components:

```
private var _documentDescriptor_{—} : mx.core.UIComponentDescriptor =
new mx.core.UIComponentDescriptor({
  type: mx.core.Application
  ,
    propertiesFactory: function( ):Object { return {
      childDescriptors: [
        new mx.core.UIComponentDescriptor({
        type: mx.controls.TileList
        ,
        id: “tlist0”
        ,
        propertiesFactory: function( ):Object { return {
          x: 10,
          y: 10,
          height: 400,
          width: 400,
          columnCount: 4,
          rowCount: 4,
          direction: “horizontal”,
          allowMultipleSelection: true,
          offscreenExtraRows: 4
        }}
      })
    ,
      new mx.core.UIComponentDescriptor({
        type: mx.controls.Button
        ,
        events: {
          click: “_CustomTileListEffect_Button2_click”
        }
        ,
        propertiesFactory: function( ):Object { return {
          x: 495,
          y: 60,
          label: “Add item”
        }}
      })
    ]
  }}
})
```

The following illustrates generated procedural code for an effect. In particular, it illustrates exemplary generated procedural code for a portion of the above illustrated declarative code:

```
private function _CustomTileListEffect_Sequence1_c( ) :
mx.effects.Sequence
{
  var temp : mx.effects.Sequence = new mx.effects.Sequence( );
  temp.children = [_CustomTileListEffect_Parallel2_c( ),
_CustomTileListEffect_Parallel3_c( )];
  return temp;
}
private function_CustomTileListEffect_Parallel2_c( ) :
mx.effects.Parallel
{
  var temp : mx.effects.Parallel = new mx.effects.Parallel( );
  temp.filter = “removeItem”;
  temp.children = [_CustomTileListEffect_Blur1_c( ),
_CustomTileListEffect_Fade1_c( )];
  return temp;
}
private function_CustomTileListEffect_Blur1_c( ) : mx.effects.Blur
{
  var temp : mx.effects.Blur = new mx.effects.Blur( );
  temp.blurYTo = 12;
  temp.blurXTo = 12;
  temp.duration = 300;
  temp.perElementOffset = 150;
  return temp;
}
```

As the preceding example illustrates, the code for the components generates a data structure describing the components, and the code for the effects generates a function that initializes and returns a data structure describing the effect. The first data structure may be temporary, i.e., processed further during initialization to set up the objects for the application. The data structure for the effect may be used to run the effect and the elements of the data structure may be elements of the framework library with associated procedural methods.

FIG. 6 is a flow chart illustrating one method of using declarative code to generate an application that displays animation according to one embodiment of the present invention. For purposes of illustration only, the elements of this method are described with reference to the system depicted in FIG. 1. A variety of other implementations are also possible.

In the method shown in FIG. 6, a development application 52 provides a library 56 for use from declarative language code to display a container and animate one or more representations of data items as shown in block 610. Procedures in one such library may comprise instructions for displaying a container and for displaying an animation effect for representations of data items within a displayed container. In other words, the procedures may contain sufficiently detailed instructions such that a developer creating the declarative language code is not burdened with specific implementation details and but can specify parameters. For example, with respect to an animation behavior, the declarative language code might specify the that a removed item will (a) fade and (b) that the duration of the fade will be 200 ms, while the procedural code in the library provides the details for implementing an animation behavior with those specified characteristics.

In the method shown in FIG. 6, a development application 52 provides a coding application for declarative code, comprising a text editor and a display design interface for creating and editing declarative code as shown in block 620. One example of such an editor is illustrated as editor 54 of development application 52 in FIG. 1. Another example is illustrated by the windows of the IDE illustrated in FIGS. 2 and 3. FIG. 2 illustrates a text editor window 108 for manually entering declarative code, while FIG. 3 illustrates a graphic design window 110 in which a user can graphically arrange components. The editor window 108 and display design window 110 may provide constraints or other features that facilitate the creation of declarative code that takes advantage of or otherwise utilizes the library.

In the method shown in FIG. 6, a development application 52 receives a file containing declarative code from the coding application as shown in block 630. Such a file can have any suitable form or format to provide the declarative code and can be provided in any suitable way, e.g., over a network or simply locally on a single machine. For example, receiving a file could simply comprise retrieving the file or some or all of its contents from memory on a computer. As a more specific example, receiving a declarative code file may involve the editor of development application 52 calling the application generator 58.

In the method shown in FIG. 6, the application generator 58 of the development application 52 generates a computer application using the library and the file of declarative language code as shown in block 640. For example, where the declarative language references one or more procedures defined or otherwise part of the library, such procedures are used according to how they are declared or specified in the declarative language code. Generally, at least some of the declarative language code will comprise declarations. However, some of the code in the declarative language file may comprise procedural code or commands.

### Illustrative Embodiment of Virtualization Embodiment

Embodiments of the present invention relate to the use of location information about an object's starting and ending positions that is used to facilitate animation and other functions. For example, when a data item representation is deleted, an adjacent representation may move from its current position to the position previously occupied by the deleted item representation. The animation of the adjacent item from its original or starting position to the ending position will typically involve specifying those positions to a function that facilitates the animation (e.g., by incrementally displaying the representation in slightly changing positions between the starting and ending position over a period of time).

Embodiments of the invention provide an application to animate objects using, or virtualizing, starting and/or ending positions outside a container's content display area, for example, to animate data-driven objects moving onto and off of the container content display area. An application may employ virtualization to generate representations for a subset of the data items outside a content display area, while not generating representations for some of the data items in a collection. Fewer than all of the data items are generally represented (either within or outside the display area) to conserve system resources such as memory. While only those data item representations (or portions thereof) having positions within the container display area are actually displayed by the application, all of the representations are available for the application to accomplish animation behavior.

Some application development frameworks, such as the Adobe® Flex® framework, use data-driven controls to specify how visual components corresponding to data elements in a collection should be displayed. A display specified using such a method is sometimes referred to as “data-driven” because the visual presentation is defined in a general manner that can be used with arbitrary data in that the specifics of the actual data determine the properties of the individual visual components that will be created to visually represent the data. In a data-driven component, changes in data may automatically be reflected visually.

One illustrative embodiment of the present invention provides a method for virtualization. Virtualization generally involves computing visual representations for some, but not all, data items in a collection of data items. For example, the number of data items represented may be limited to a set number of representations, which, given a sufficiently large data collection, results in less that the entire data collection being represented. Virtualization may be accomplished in a variety of ways and generally results in computational resource savings. Another benefit of virtualization according to embodiments of the present invention is extra flexibility for animation, e.g., in animating transitions corresponding to data changes. An embodiment provides a method for animating visual components representing individual data items within the context of a data-driven component using virtualization.

As an example of virtualization, a layout might include the positions (and perhaps sizes and/or dimensions) of visual components for items 20 through 60 out of 100 items, even though only items 30-50 are currently visible. An animation module may determine ending positions and sizes for an animation using a layout constructed from the current data and starting positions and sizes from a layout using the prior state of the data. From the start and end values, it is able to animate the properties of the visual components over time. Thus, one feature of this embodiment is tracking components beyond those currently visible on screen for purposes of computing start and end points for animation, while still restricting the range of components that are actually displayed to reduce computational overhead.

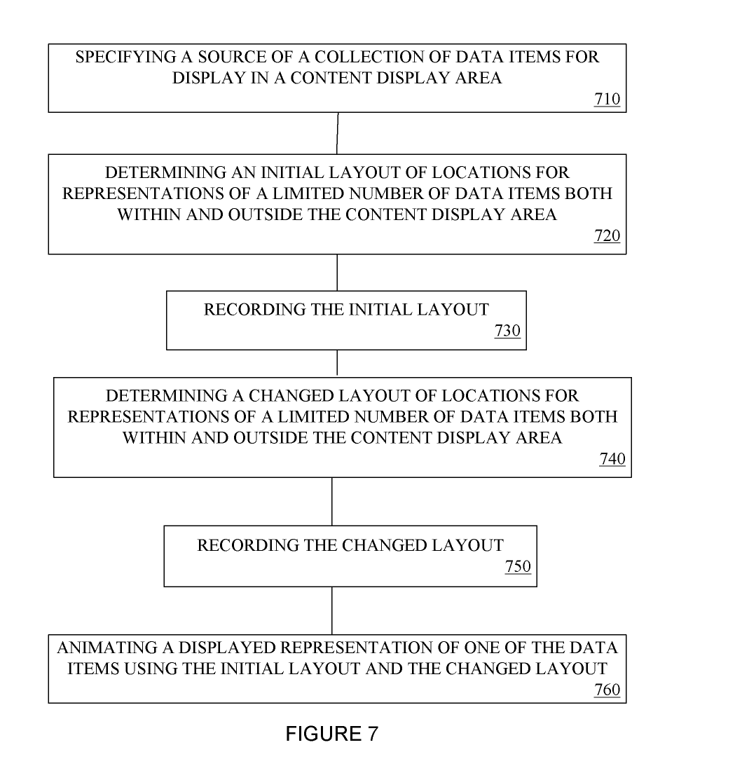

FIG. 7 is a flow chart illustrating one method for animating representations of data items according to one embodiment of the present invention. For purposes of illustration only, the elements of this method are described with reference to the system depicted in FIG. 1. A variety of other implementations are also possible.

In the method shown in FIG. 7, an application 22 provided from web server 20 in FIG. 1, specifies a source of a collection of data items for display in a content display area as shown in block 710. Examples of sources include a file locations, web sites, local and external applications, and data items entered by a user. As a more specific example, the source could be the location data source 40 depicted in FIG. 1 and accessible over a network 40 to provide data items 42a-n of a collection of data 42. One of skill in the art would understand that many other sources of data may be utilized with the embodiments of the invention.

In the method shown in FIG. 7, a virtual machine which may for example be a part of player 32 of FIG. 1, determines an initial layout as shown in block 720. To determine a layout, a virtual machine may run a layout algorithm implemented from library or other source code. The layout specifies the representations of certain data items that are displayed within a content display area. However, the layout may additionally specify locations for representations of some data items outside of the content display area. While the virtual machine determines a layout that includes representations that are viewable (i.e., within the content area) and also additional representations, to conserve system resources the layout does not necessarily provide representations of all data items in a given collection of data items.

In the method shown in FIG. 7, the player records the initial layout as shown in block 730. The player may use a data structure to record the details of the layout such as the positions and other relevant characteristics of the representations in the layout as well as the data item related to each representation. This may be accomplished, for example, by saving the locations of the representations of the layout as a data structure in memory on a local or remote computing device. As another example, recording the initial layout may simply involve recording location data for each representation of the initial layout.

In the method shown in FIG. 7, the player determines a changed layout based on a change as shown in block 740. This will typically involve determining the changed layout of locations for representations of a limited number of data items both within and outside the content display area. The change may be a change made to the displayed layout (e.g., by a user interacting with the represented data items), a change to the underlying data items in the data collection, or may be a change otherwise initiated by or related to an application displaying the representations.

In the method shown in FIG. 7, the player records the changed layout as shown in block 750. As with recording the initial layout 730, recording the changed layout may be accomplished, for example, by saving the locations of the representations of the layout as a data structure in memory on a local or remote computing device. Generally, recording the changed layout will not overwrite the recorded initial layout, allowing both the initial layout and changed layout to be available for computations, including animation.

In the method shown in FIG. 7, the player's rendering engine animates a displayed representation of one of the data items using the initial layout and the changed layout as shown in block 760. Animating the representation may involve using the initial layout to determine a starting position and using the changed layout to determine an ending position. An example of animating a displayed representation of one of the data items using the initial layout and the revised layout is moving a data representation between a first location associated with the initial layout and a second location associated with the changed layout. Another example of animating a displayed representation of one of the data items using the initial layout and the revised layout is fading the data item from the display over a period of time.

The method illustrated in FIG. 7 may further comprise displaying a content display area and representations of data items within the content display area according to the initial layout. In such a case, the change may be the result of a user action changing a representation of a data item displayed within the content display area. Examples of user action are deleting, inserting, replacing, moving, zooming, or magnifying one or more representations of data items.

One embodiment of the present invention provides tracking of data changes for purposes of computing start and end coordinates for animation. Such tracking may address problems that may result when the currently displayed representations do not match the current underlying data items for on reason or another.

Tracking data modifications may be accomplished by any suitable mechanism or technique, including by keeping a sorted list of list annotations correlated to the underlying data collection. Such annotations may be added automatically when events signaling changes to the underlying collection occur. For example, such events may provide information about the specific changes that were made to the collection. As a specific example, a list annotation might provide information that item x was deleted at position 5 or that the item at position 7 was recently added. The annotations may be tracked using a wrapper that references the original component and has additional properties, e.g., data structures representing changes. A wrapper may present the same interface as the original component so that it can be used directly to specify the layout, i.e., used by code that generates the representations of data items by supporting operations such as getting the element at a given position. For example, if there are 1000 data items in a collection, and item 500 is removed, a wrapper object is available that has a reference to the original collection plus a list of changes (i.e., the item that was deleted at position 500). If the wrapper is asked for the item at position n, it returns n from the original (now modified) collection if n is <500, returns the deleted item if n is 500, and returns the item n−1 from the original collection if n>500. Alternatively, the wrapper can selectively ignore the list of changes and return item n from the original collection. The specifics of using data structures according to this embodiment may, of course, vary in order to improve efficiency or to satisfy other design criteria, as will be apparent to those in the art.

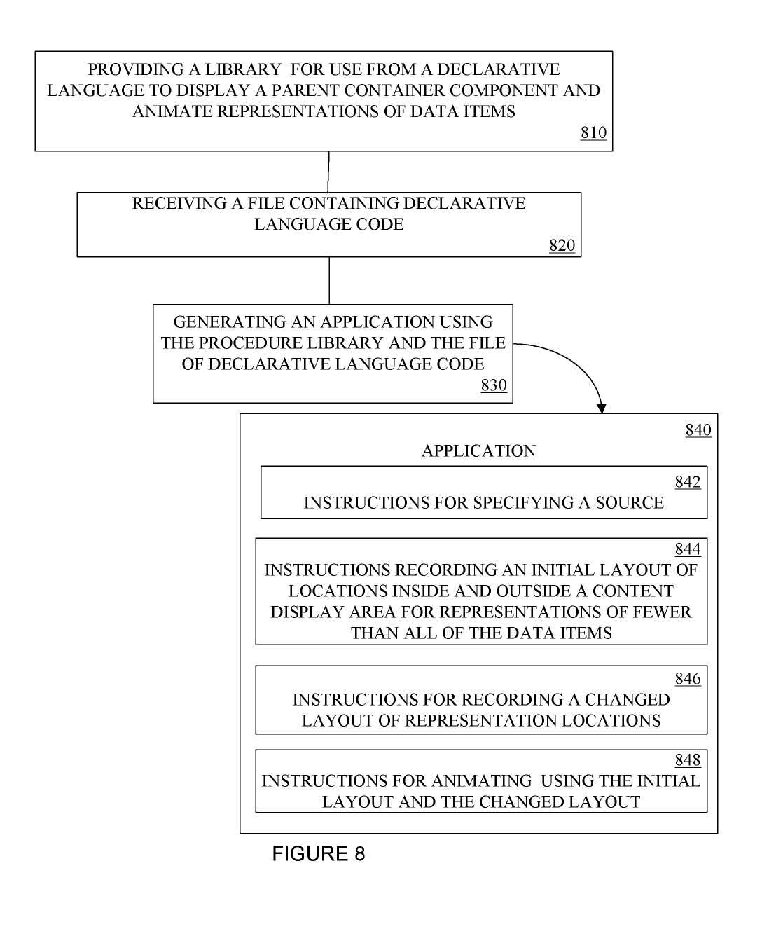

FIG. 8 is a flow chart illustrating one method of using declarative code to generate an application that displays animation according to one embodiment of the present invention. For purposes of illustration only, the elements of this method are described with reference to the system depicted in FIG. 1. A variety of other implementations are also possible.

In the method shown in FIG. 8, a development application 52 provides a library for use from a declarative programming language to display a container and animate representations of data items as shown in block 810. The library may contain procedural code used by the declarative programming language code. The procedures in this example comprise instructions for displaying containers and for displaying one or more animation effects for representations of data items. For example, the instructions may cause the display of an animation effect in response to a user action (e.g., deletion of a representation of a data item from a list box) on a computer executing the application. The instructions may provide for maintaining a data structure for tracking changes made to the one or more data items.

In the method shown in FIG. 8, an application generator 58 of the development application 52 receiving a file containing declarative language code as shown in block 820. Such a file can have any suitable form or format to provide the declarative code and can be provided in any suitable way, e.g., over a network or simply locally on a single machine. For example, receiving a file could simply comprise retrieving the file or some or all of its contents from memory on a computer. As a more specific example, receiving a declarative code file may involve the editor of development application 52 calling the application generator 58.

In the method shown in FIG. 8, the application generator 58 of the development application 52 generates an application using the library and the file of declarative language code as shown in block 830. Such an application 840 may comprise instructions 842 specifying a source of a collection of data items for display in a content display area, instructions 844 for recording an initial layout comprising locations for representations of one or more of the data items within a content display area and locations for representations of fewer than the remaining data items of the collection outside the content display area, instructions 846 for recording a changed layout based on a change, the changed layout comprising locations for representations of one or more of the data items within the content display area and locations for representations of fewer than the remaining data items of the collection outside the content display area, and instructions 848 for animating a displayed representation of one of the data items using the initial layout and the changed layout.

Selectively laying out off-screen components offers other advantages in addition to facilitating basic animation. For example, the selective layout of off-screen components may facilitate running transition effects while a user is scrolling and computing the start or end positions of items that start off-screen but end up onscreen, and vice-versa. It may do this without incurring the computational overhead (CPU and memory usage) of always constructing a complete layout that would include the positions and sizes of visual components corresponding to every data item.

As an alternative to selectively laying out off-screen components, the start and end positions and sizes may be computed on an as needed basis or only for the items currently determined to be visible onscreen. Such embodiments could determine location for use in animation without actually generating a layout. Rather it may use an algorithm on an as needed basis to figure out where representations of display items are supposed to be located.

### Illustrative Embodiment of Representation Layouts

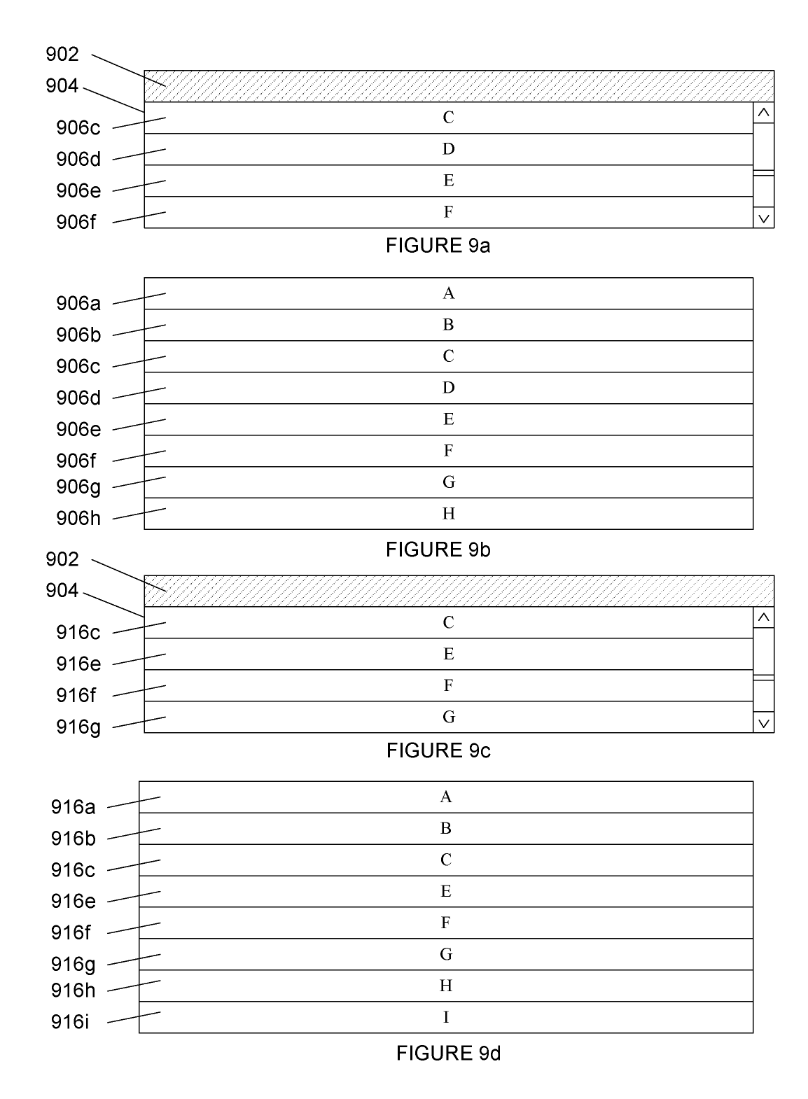

FIGS. 9a-d illustrate representations of data items and the use of layouts according to one embodiment of the present invention. FIGS. 9a and 9c illustrate a displayed container 902 with a content display area 904. FIG. 9a displays four representations of data items shown here as boxes with text labels C, D, E, and F respectively labeled 906c, 906d, 906e, 906f. FIG. 9c illustrates an exemplary resulting display after representation D 906d is deleted from the display 902. As shown in FIG. 9c, representation C 916c occupies the same location as it did in the representation of C 906c in FIG. 9a. Representations E 916e and F 916f each shift up one position to occupy the positions occupied by representations D 906d and E 906e, respectively, in FIG. 9a. Additionally, representation G 916g appears in the position occupied by 906f in FIG. 9a.

FIGS. 9b and 9d illustrate layouts of representations of data items. FIG. 9b illustrates an initial layout (i.e., a layout prior to the deletion of D) that is associated with the display 902 of FIG. 9a. Note that the layout of FIG. 9b includes more representations 906a, 906b, 906c, 906d, 906e, 906f, 906g, 906h than are within the content area 904 of FIG. 9a. Items outside the content area 906a, 906b, 906g, 906h are not displayed in FIG. 9a. Note further that a data collection from which data items underlying the representations may (and preferably does) include data elements in addition to those given representations in the layout depicted in FIG. 9b. In other words, a restricted number or representations, typically fewer than all of the them, are represented in the layout of FIG. 9b. An application displaying display 902 may specify the display of the layout of FIG. 9b to the extent the layout is within the content display area 904.

FIG. 9d is a layout corresponding to the display of FIG. 9c. FIG. 9D illustrates a changed layout (i.e., a layout after the deletion of D) that is associated with the display 902 of FIG. 9c. Note, similar to the example of FIG. 9b , that the layout of FIG. 9d includes more representations 916a, 916b, 916c, 916e, 916f, 916g, 916h, 916i than are within the content area 904 of FIG. 9c. Items outside the content area 916a, 916b, 916h, 916i are not displayed in FIG. 9c.

The layouts (or data associated with the layouts) of FIGS. 9b and 9d is used in certain embodiments of the invention to animate a transition between the display 902 as it changes from the display depicted in FIG. 9a to the display depicted in 9c. For example, animation of representation E moving from 906e to 916e can be facilitated by retrieving an initial position from the layout of FIG. 9b and a changed position from the layout of FIG. 9d. Similarly, animation of representation G moving onto the display from the bottom of content area 904 and into position 916g can be facilitated by retrieving an initial position from the layout of FIG. 9b and a changed position from the layout of FIG. 9d. The use of layouts in this manner thus provides a virtual initial position for an off screen object such as representation G without necessarily requiring system resources to store virtual positions for representations associated with all of the data items in a data item collection.

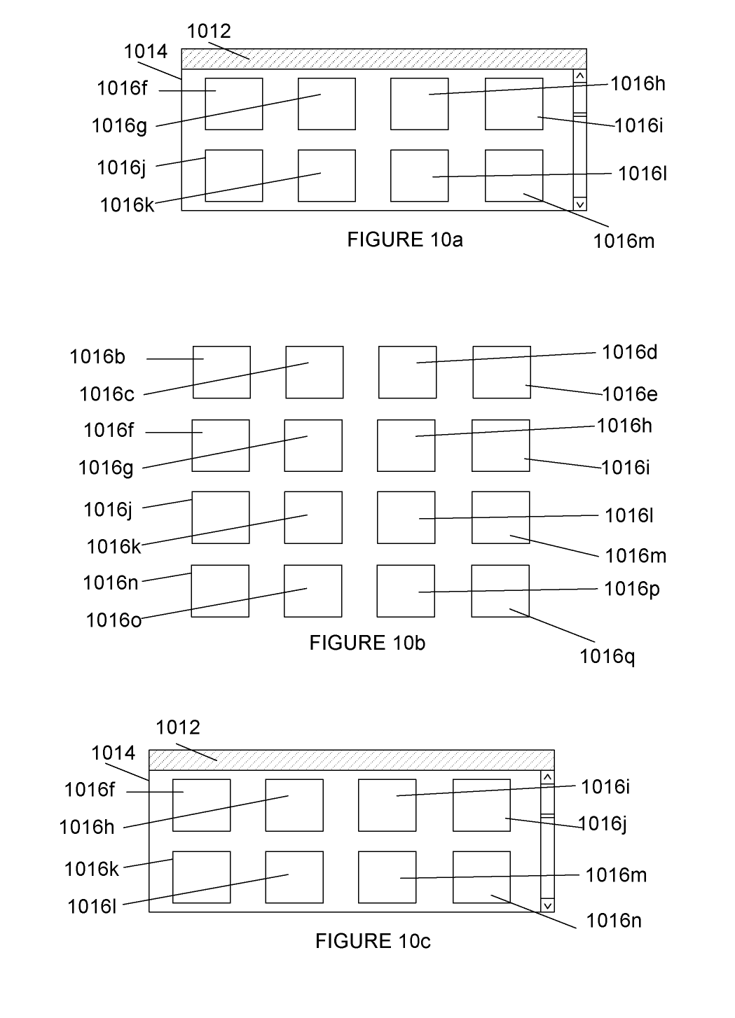

FIGS. 10a-d illustrate representations of data items in a container according to one embodiment of the present invention. Thus, in contrast to FIG. 9, which illustrates an embodiment related to a linear list container that uses sequential layout algorithms to put one item below another, FIG. 10 illustrates an embodiment related to a tilelist (e.g., a grid of photo thumbnails) that uses a fixed positioning algorithm. Thus one difference between such layouts is that the positions of objects displayed in a linear lists typically depend on the size of the items in the list, whereas the positions of objects displayed in tilelists typically does not depend on the size of other items because each object is given a fixed position that doesn't depend on the size of the other objects.

Generally, a tilelist will generally have either a horizontal layout with a fixed number of columns or width or a vertical layout fixed number of rows or height) layout. FIG. 10, illustrates a horizontal layout, in which sequential representations of data items from a data collection are positioned one after another first horizontally across a row and then horizontally across the next row, etc. The vertical scroll bar is used to access additional rows of represented data items.

FIGS. 10a and 10c illustrate a displayed container 1012 with a content display area 1014. FIG. 10a displays eight representations of data items shown here as boxes 1016f, 1016g, 1016h, 1016i, 1016j, 1016k, 1016l, 1016m. FIG. 10c illustrates an exemplary resulting display after the second representation 1016g is deleted. As shown in FIG. 10c, the first representation 1016f occupies the same location as it did in the display of FIG. 10a. The third, fourth, sixth, seventh, and eighth representations 1016h, 1016i, 1016k, 1016l, 1016m each shift left one position. The fifth representation shifts from its lower left position in the display of FIG. 10a to its upper right position in the display of FIG. 10c. Additionally, a ninth representation 1016n appears in a lower right position in the display of FIG. 10c.

FIG. 10b illustrates an initial layouts of representations of data items. Note that the layout of FIG. 10b includes more representations than are displayed within the content area of FIG. 10a. Items outside the content area 1014 including representations labeled 1016b, 1016c, 1016d, 1016e, 1016n, 1016o, 1016p, 1016q are not displayed in FIG. 9a. Note further that a data collection from which data items underlying the representations may (and preferably does) include data elements in addition to those given representations in the layout depicted in FIG. 10b. In other words, a restricted number or representations, typically fewer than all of the them, are represented in the layout of FIG. 10b. An application displaying display 1012 may specify the display of the layout of FIG. 10b to the extent the layout is within the content display area 1014.

A layout corresponding to the changed display and a subset of additional representations may also be generated and associated with the displayed representations of FIG. 10c. The initial layout of FIG. 10b and changed layout (not shown) or data associated with the layouts may, as described above, be used for virtualization and/or animation.

### GENERAL

The foregoing description of the embodiments of the invention has been presented only for the purpose of illustration and description and is not intended to be exhaustive or to limit the invention to the precise forms disclosed. Numerous modifications and adaptations are apparent to those skilled in the art without departing from the spirit and scope of the invention.

That which is claimed:

1. A method for animating displayed objects comprising:
receiving a collection of data items for display in a content display area;
determining an initial layout of representations of each of the data items, wherein a first subset of the representations are within the content display area and a second subset of the representations are not within the content display area;
receiving a change;
determining a changed layout based on the change;
determining an animation effect to be applied to the content area to transition from the initial layout to the changed layout; and
causing the animation effect to be displayed.

2. The method of claim 1, wherein the change comprises a change to a representation of a data item displayed in the content display area.

3. The method of claim 1, wherein the change comprises a change to a data item in the data collection.

4. The method of claim 1, wherein determining the animation effect further comprises
determining a starting position based at least in part on the initial layout; and
determining an ending position based at least in part on the changed layout.

5. The method of claim 1, wherein the initial layout comprises a location for each representation of each data item.

6. The method of claim 1, wherein the initial layout comprises size data for each representation of each data item.

7. The method of claim 2, wherein the change is associated with a user action.

8. The method of claim 7, wherein the user action comprises one of: deleting, inserting, replacing, moving, or zooming one or more representations of each of the data items.

9. The method of claim 1, wherein determining an animation effect to be applied to the content area to transition from the initial layout to the changed layout moving one of the data representation of the data items between a first location associated with the initial layout and a second location associated with the changed layout.

10. The method of claim 1, wherein determining an animation effect to be applied to the content area to transition from the initial layout to the changed layout comprises fading the representation of the data item from the content display area over a period of time.

11. A method of creating an animated application comprising:
providing a library comprising instructions for displaying container and for displaying an animation effect for representations of data items within a displayed container;
receiving a file containing declarative language code; and
generating an application using the library and the file of declarative language code, the application comprising:
(a) instructions specifying a source of a collection of data items for display in a content display area;
(b) instructions for determining and recording an initial layout comprising locations for representations of one or more of the data items within a content display area and locations for representations of fewer than the remaining data items of the collection outside the content display area;
(c) instructions for determining and recording a changed layout based on a change, the changed layout comprising locations for representations of one or more of the data items within the content display area and locations for representations of fewer than the remaining data items of the collection outside the content display area; and
(d) instructions for animating a displayed representation of one or more of the data items using the initial layout and the changed layout.

12. The method of claim 11, wherein instructions for animating the displayed representation further comprises instructions specifying an animation effect to occur in response to user action on a computer executing the application.

13. The method of claim 12, wherein the user action one or more of: (i) deletion of a representation of a data item; (ii) insertion of a representation of a data item; (iii) moving a representation of a data item; or (iv) modifying a representation of a data item.

14. The method of claim 11, wherein the declarative language code specifies a number of representations of data items outside the content display area in the initial and changed layouts.

15. A computer-readable medium on which is encoded program code for providing a rich Internet application development system, the program code comprising:
program code for specifying a source of a collection of data items for display in a content display area;
program code for determining an initial layout comprising locations for representations of a limited number of the data items, some of the locations within and some of said the locations outside of a content display area;
computer-readable medium for recording the initial layout;
program code for determining a changed layout based on a change, the changed layout comprising locations for representations of a limited number of the data items, some of the locations within and some of said the locations outside of a content display area;
program code for recording the changed layout; and
program code for animating a displayed representation of one of the data items using the initial layout and the changed layout.

16. The computer-readable medium of claim 15 further comprising program code for specifying an animation effect to occur when a change occurs in the collection of data items.

17. The computer-readable medium of claim 15 further comprising program code for specifying an animation effect to occur in response to user action.

18. The computer-readable medium of claim 16, wherein the user action one or more of: (i) deletion of a representation of a data item; (ii) insertion of a representation of a data item; or (iii) moving a representation of a data item.

19. The computer-readable medium of claim 15 further comprising program code for specifying a number of representations of data items outside the content display area in the initial and changed layouts.

20. The computer-readable medium of claim 15 further comprising program code for animating a representation using an initial position of a representation on the initial layout and a changed position of the representation on the changed layout.
